(19) United States
(12) Patent Application Publication
(10) Pub. No.: US 2008/0055792 A1
(43) Pub. Date: Mar. 6, 2008

(54) MEMORY CELLS AND DEVICES HAVING MAGNETORESISTIVE TUNNEL JUNCTION WITH GUIDED MAGNETIC MOMENT SWITCHING AND METHOD

(75) Inventors: Yuankai Zheng, Singapore (SG); Jinjun Qiu, Singapore (SG)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: AGENCY FOR SCIENCE, TECHNOLOGY AND RESEARCH, Singapore (SG)

(21) Appl. No.: 11/683,153

(22) Filed: Mar. 7, 2007

Related U.S. Application Data
(60) Provisional application No. 60/779,421, filed on Mar. 7, 2006.

(51) Int. Cl. G11B 5/33

(52) U.S. Cl. 360/324.2

(57) ABSTRACT

A magnetoresistive memory cell includes a magnetic tunnel junction (MTJ). The MTJ includes a magnetic layer having a pinned magnetic moment, a tunneling layer, and a free layer. The free layer includes first and second ferromagnetic layers having respective first and second free magnetic moments, which are anti-ferromagnetically coupled to each other and align with a preferred axis of alignment in the absence of an applied magnetic field. The MTJ has an electrical resistance dependent on the direction of one of the free magnetic moments. The memory cell also includes a guide layer formed of a ferromagnetic material providing a guiding magnetic moment, which is configured and positioned so that the guiding magnetic moment is more strongly magnetically coupled to the second free magnetic moment than to the first free magnetic moment, and is aligned with the axis in the absence of the applied magnetic field.

### CROSS REFERENCE TO RELATED APPLICATIONS

This applications claims the benefits of related U.S. Provisional Application Ser. No. 60/779,421, filed Mar. 7, 2006, the contents of which are incorporated herein by reference.

### FIELD OF THE INVENTION

The present invention relates to magnetic memory devices, particularly magnetoresistive memory devices and cells with magnetoresistive tunnel junctions, and related methods.

### BACKGROUND OF THE INVENTION

Magnetoresistive memory cells (MMC) are useful in memory devices, such as magnetoresistive random access memory (MRAM) devises. The basic structure for a typical MMC includes a magnetic tunnel junction (MTJ), which has a pinned layer, a free layer, and a tunneling layer sandwiched between the pinned and free layers. The pinned layer has a pinned magnetic moment that has a fixed direction under operating conditions and the free layer has a free magnetic moment that can change direction under an applied field. Depending on the direction of the free magnetic moment in the free layer, the electrical resistance of the cell changes. Typically, the free magnetic moment is switched between two opposite directions by applying a switching magnetic field. Thus, the cell has two possible states and can store a binary data bit. To change the cell state, i.e. write a data bit to it, an appropriate switching field is generated using electrical current and applied to the cell. To detect the cell state, i.e. read the data bit stored, the electrical resistance of the cell is measured.

In a particular conventional MMC, each of the pinned and free layers has a tri-layer structure, known as the synthetic anti-ferromagnetic (SAF) structure, which includes two ferromagnetic layers and an anti-ferromagnetic coupling layer sandwiched therebetween. The two ferromagnetic layers are anti-ferromagnetically coupled and their easy axes are aligned so that in the absence of an applied field, the magnetic moments of the two layers are anti-parallel, thus acting as balancing magnetic moments with respect to each other. The magnetic moments of the ferromagnetic layers in the pinned layer are fixed. The net magnetic moment of the pinned layer can be non-zero (unbalanced) or zero (balanced). The magnetic moments of the two ferromagnetic layers of the free layer can be reversed in direction when a switching field is applied to the free layer. The electrical resistance of the cell is dependent on the direction of the magnetic moment in the ferromagnetic layer (referred to herein as the junction layer) of the free layer that is adjacent to the tunneling layer. When the free layer is unbalanced, the threshold for the switching field is reduced. The MMC can be configured so that it can be written in either a direct mode (only available if the free layer is unbalanced) or a toggle mode (available when the free layer is balanced). In the direct mode, the threshold for the switching field is reduced and the cell state after each write depends on the direction of the applied switching field but independent of the initial state of the cell. In the toggle mode, each write switches (toggles) the state of the cell regardless of its initial state and the direction of the applied switching field.

This particular MMC has some drawbacks. For example, the write result is sensitive to the strength of the applied switching field. When the applied switching field is high (saturated), attempted write can fail as when the switching field is removed the coupled magnetic moment has an even chance of turning to any one of two opposite directions. In addition, on the one hand, data loss rate is significant in the direct mode due to the low switching field threshold; on the other hand, in the toggle mode it is necessary to read the cell before each write to ensure the correct data bit will be written. Further, precise timed sequence of electrical current pulses is required to generate the correct switching field. If the timing is off, an attempted write can fail.

Accordingly, there is a need to provide a free layer that overcomes one or more of these drawbacks. There is also a need to provide free layers, MMCs, and MRAM devices that are simple to operate. There is a further need for an improved method to operate these cells and devices.

### SUMMARY OF THE INVENTION

In an aspect of the present invention, there is provided a magnetoresistive memory cell. The cell comprises a magnetic tunnel junction (MTJ). The MTJ comprises a magnetic layer having a pinned magnetic moment, a tunneling layer adjacent the magnetic layer, and a free layer adjacent the tunneling layer. The free layer comprises a first ferromagnetic layer having a first free magnetic moment, and a second ferromagnetic layer having a second free magnetic moment anti-ferromagnetically coupled to the first free magnetic moment, the first and second magnetic moments aligning with a preferred axis of alignment in the absence of an applied magnetic field. The MTJ has an electrical resistance dependent on the direction of one of the first and second free magnetic moments. The memory cell also comprises a guide layer formed of a ferromagnetic material providing a guiding magnetic moment, the guide layer configured and positioned so that the guiding magnetic moment is more strongly magnetically coupled to the second free magnetic moment than to the first free magnetic moment, and is aligned with the axis in the absence of the applied magnetic field.

The first ferromagnetic layer may be adjacent to the tunneling layer. The guiding magnetic moment may be ferromagnetically coupled to the second free magnetic moment. The guiding magnetic moment may be anti-ferromagnetically coupled to the second free magnetic moment. The magnetoresistive memory cell may comprise an anti-ferromagnetic coupling layer sandwiched between the first and second ferromagnetic layers, providing anti-ferromagnetic coupling between the first and second free magnetic moments. The magnetoresistive memory cell may comprise a spacer layer sandwiched between the second ferromagnetic layer and the guide layer.

The guide layer may have a coercivity of less than 100 Oe. The guide layer may have a thickness of less than 5 nm. The first and second free magnetic moments may be balanced. The pinned layer may comprise a ferromagnetic layer, or a synthetic anti-ferromagnetic (SAF) structure. The SAF structure may comprise a third ferromagnetic layer and a fourth ferromagnetic layer anti-ferromagnetically coupled to the third ferromagnetic layer. The third ferromagnetic layer has a third magnetic moment and the fourth ferromagnetic layer has a fourth magnetic moment. At least one of the third and fourth magnetic moments is pinned in a direction parallel to the axis. The third and fourth magnetic moments may be balanced. The pinned layer may comprise an anti-ferromagnetic coupling layer sandwiched between the third and fourth ferromagnetic layers, for anti-ferromagnetically coupling the third and fourth magnetic moments. The pinned layer may comprise an anti-ferromagnetic layer adjacent the third ferromagnetic layer, for pinning the third magnetic moment.

According to another aspect of the present invention, there is provided a memory device comprising the magnetoresistive memory cell described above. The memory device may comprise electrically conductive write lines for inducing the switching field in the magnetoresistive memory cell. The write lines may comprise a word line and a bit line, the word and bit lines overlapping at an intersection, the magnetoresistive memory cell being located between the word and bit lines at the intersection. The word and bit lines may be perpendicular to each other. The preferred axis of alignment may be at 45 degrees relative to each one of the word and bit lines.

According to another aspect of the present invention, there is provided a memory device comprising a plurality of memory cells each according to the magnetoresistive memory cell described above. The memory device may comprise a plurality of first electrical conductive lines, and a plurality of second electrical conductive lines, the first lines overlapping the second lines at a plurality of intersections, each one of the memory cells located at an intersection between the first and second lines that overlap at the intersection. The first lines are perpendicular to the second lines. The preferred axis of alignment in each one of the memory cells is at 45 degrees relative to each one of the first and second lines that overlap at the intersection of the cell.

According to a further aspect of the present invention, there is provided a method of aligning a magnetic moment in a free layer of a magnetic tunnel junction (MTJ). The MTJ has an electrical resistance dependent on the direction of the magnetic moment. The free layer comprises a first layer providing the magnetic moment and a second layer providing another magnetic moment anti-ferromagnetically coupled therewith, the first and second layers having an easy axis. The method comprises coupling a guiding magnetic moment more strongly with a first one of the magnetic moments than with a second one of the magnetic moments, the guiding magnetic moment rotatable by a magnetic field; applying a magnetic field in a direction aligned with the axis to rotate at least one of the magnetic moments, and to align the guide magnetic moment in the field direction; and removing the magnetic field, to allow re-alignment of the magnetic moments with the axis, wherein the first magnetic moment is aligned in the field direction due to the coupling with the guide magnetic moment. The electrical resistance may be dependent on the direction of the second magnetic moment. The guide magnetic moment may be ferromagnetically, or anti-ferromagnetically, coupled to the first magnetic moment.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic partial top view of a memory device, exemplary of an embodiment of the present invention;

FIG. 2 is an enlarged perspective view of a memory cell in the memory device of FIG. 1;

FIG. 3 is a cross-sectional view of the memory cell in the memory device of FIG. 1 along the line A;

FIG. 4 is a schematic diagram illustrating the directions of magnetic moments and applied magnetic field in the memory cell of FIGS. 2 and 3;

FIG. 5 is a cross-sectional view of the free layer shown in FIG. 3;

FIG. 6A is a schematic diagram illustrating electrical current signals for effecting a write operation in the memory cell of FIG. 3;

FIG. 6B is a schematic diagram illustrating the responses of magnetic moments in the free layer of FIG. 5 to the current signals of FIG. 6A;

FIG. 6C is a schematic diagram illustrating different electrical current signals for a different write operation in the memory cell of FIG. 3;

FIG. 6D is a schematic diagram illustrating the responses of magnetic moments in the free layer of FIG. 5 to the current signals of FIG. 6C;

FIG. 7A is a schematic diagram illustrating large electrical current signals for a saturate write operation in the memory cell of FIG. 3;

FIG. 7B is a schematic diagram illustrating the responses of magnetic moments in the free layer of FIG. 5 to the current signals of FIG. 7A;

FIG. 7C is a schematic diagram illustrating large electrical current signals for a different saturate write operation in the memory cell of FIG. 3;

FIG. 7D is a schematic diagram illustrating the responses of magnetic moments in the free layer of FIG. 5 to the current signals of FIG. 7C;

FIG. 8A is a schematic diagram illustrating electrical current signals in a half-selected cell;

FIG. 8B is a schematic diagram illustrating the responses of the magnetic moments in the free layer of FIG. 5 to the current signals of FIG. 8A;

FIG. 8C is a schematic diagram illustrating different electrical current signals in a half-selected cell;

FIG. 8D is a schematic diagram illustrating the responses of the magnetic moments in the free layer of FIG. 5 to the current signals of FIG. 8C;

FIG. 9 is a cross-sectional view of an alternative memory cell;

FIG. 10 is a simulated phase diagram showing the safe and error ranges of applied magnetic field for a sample memory cell; and

FIGS. 11A and 11B are graphs of measured electrical resistance as functions of applied magnetic field in a sample memory cell.

### DETAILED DESCRIPTION

In overview, an exemplary embodiment of the present invention relates to a method of switching the free magnetic moment in the free layer of a magnetic tunnel junction (MTJ). As in a typical MTJ, the free layer has an easy axis, which is the preferred axis of alignment for the free magnetic moment in the absence of an applied magnetic switching field. The free magnetic moment is anti-ferromagnetically coupled with a balancing magnetic moment. The MTJ has an electrical resistance dependent on the direction of the free magnetic moment.

The method includes coupling a first one of the free and balancing magnetic moments with a guiding magnetic moment, more strongly than to a second one of the free and balancing magnetic moments, for guiding alignment of the first magnetic moment after the removal of an applied magnetic switching field. The guiding magnetic moment is itself rotatable in the applied magnetic switching field. The switching field is momentarily applied to the free layer in a direction aligned with the easy axis to rotate at least one of the free and balancing magnetic moments, and to align the guide magnetic moment in the field direction. The switching field is then removed to allow re-alignment of the free and balancing magnetic moments with the easy axis. During re-alignment, the first magnetic moment will align in the same direction as the field direction due to its coupling with the guide magnetic moment. Thus, the directions of the free and balancing magnetic moments after field removal is predicable even when they are symmetrically aligned with the easy axis in the presence of the switching field. As such, certain benefits and advantages can be obtained as will become clear below. To improve performance, the guide magnetic moment may be substantially more strongly coupled to the guided magnetic moment than to the unguided magnetic moment. Alternatively, there may be no or insubstantial direct magnetic coupling between the guide magnetic moment and the unguided magnetic moment.

This method can be implemented using an improved magnetoresistive memory cell, also exemplary of an embodiment of the present invention. For example, the cell may include an MTJ, which has a pinned layer, a tunneling layer adjacent the pinned layer, and a free layer adjacent the tunneling layer. The free layer may have two ferromagnetic layers each having a free magnetic moment. The two free magnetic moments are anti-ferromagnetically coupled with each other, and align with a preferred axis of alignment in the absence of an applied magnetic field. The MTJ has an electrical resistance dependent on the direction of one of the free magnetic moments. The cell also includes a guide layer formed of a ferromagnetic material providing the guiding magnetic moment. The guide layer is configured and positioned so that the guiding magnetic moment is more strongly magnetically coupled to one of the free magnetic moments than to the other free magnetic moment and is aligned with the axis in the absence of the applied magnetic field.

The above memory cell may be advantageously included in memory devices such as magnetoresistive random access memory (MRAM) devices. Such devices and cells and their operation are illustrated in more detail below and in the figures.

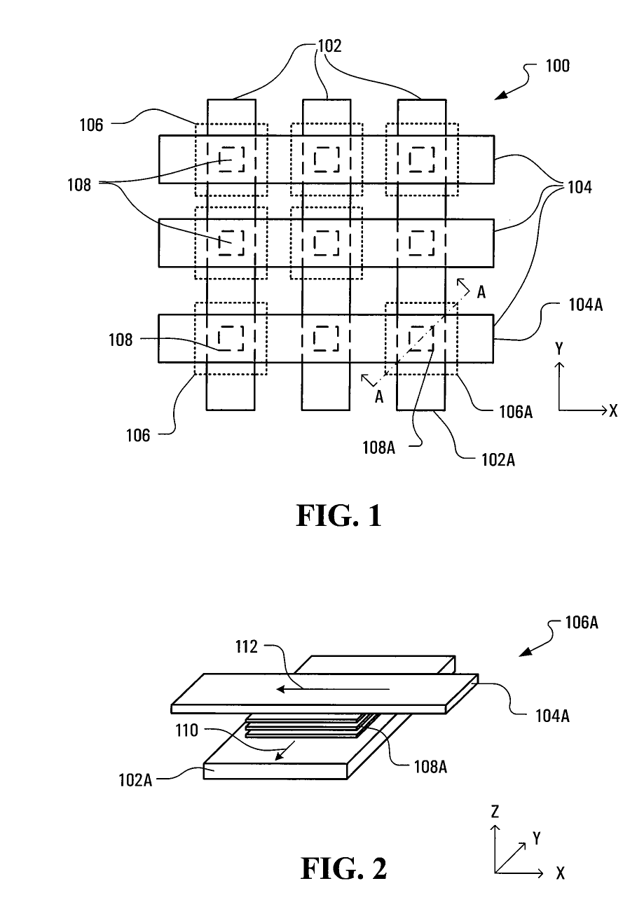

FIG. 1 illustrates a partial MRAM device 100, exemplary of an embodiment of the present invention. Device 100 includes a plurality of electrically conductive word lines (both collectively and individually referred to as 102), which overlap a plurality of electrically conductive bit lines (both collectively and individually referred to as 104) at a plurality of intersections (both collectively and individually referred to as 106). The word and bit lines are both referred to as write lines 102/104. As shown, word lines 102 are parallel to each other and are perpendicular to bit lines 104. In a different embodiment, the write lines may otherwise overlap, such as at angles greater or smaller than 90 degrees.

The construction and functions of write lines 102/104 may be similar to the word and bit lines in a conventional MRAM device. Write lines 102/104 may be connected to a circuit or a signal generator (not shown) for generating electrical currents, therein. An electrical signal may be applied independently to any selected word line 102 and bit line 104. As can be understood, different write lines may be individually identifiable so that the location of each intersection 106 is identifiable and addressable.

A memory cell 108 is located at each intersection 106 of a word line 102 and a bit line 104. For example, memory cell 108A is located at the intersection of word line 102A and bit line 104A. The memory cells are also collectively referred to as memory cells 108.

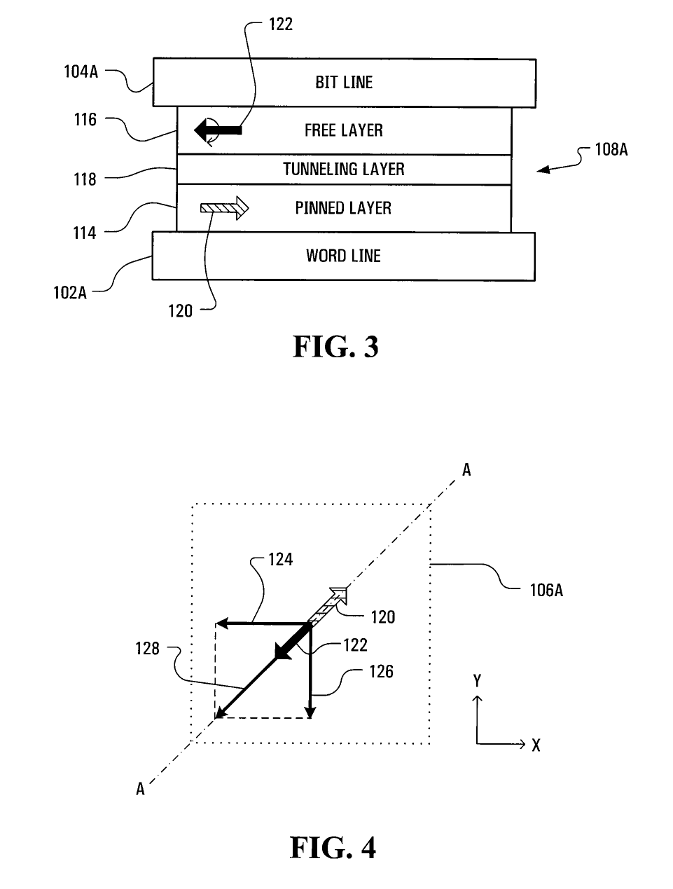

A representative memory cell 108A is illustrated in FIGS. 2 and 3. For illustrative purpose, the corresponding write lines, word line 102A and bit line 104A are also shown in FIGS. 2 and 3. As will be further described below, electrical signals to generate electrical current 110 or 112 can be respectively applied to each of write line 102A/104A. While the directions of currents 110 and 112 are indicated in FIG. 2, it should be understood that they can be reversed. As is typical and will be further discussed below, signals applied to write lines 102A/104A are used to induce a switching magnetic field in memory cell 108A. As will become apparent, the correct switching field is only induced when electrical currents 110 and 112 are respectively flown through both write lines 102A and 104A concurrently. That is, the state of memory cell 108A will not be switched if only one of currents 110 or 112 is present or when the current pulses do not overlap in time, as will become clear below. When the current creating signals are applied to both write lines 102A and 104A, cell 108A is referred to as the selected cell. When a current creating signal is applied to only one of write lines 102A and 104A, cell 108A is referred to as a half-selected cell. As can be appreciated, it is possible to select only one cell, such as 108A, from all the cells 108 on device 100 (see FIG. 1). Conveniently, each of memory cells 108 may be independently addressed, or selected, by applying a current creating signal to the word line 102 and bit line 104 at the intersection associated with that memory cell.

As better illustrated in FIG. 3, memory cell 108A includes several ferromagnetic or magnetic layers formed between word line 102A and bit line 104A. As illustrated, memory cell 108A has a pinned layer 114, a free layer 116, and a tunneling layer 118 sandwiched between the pinned and free layers 114 and 116. Each of pinned and free layers 114 and 116 may further include sub-layers, as will be illustrated below.

Pinned layer 114 is formed of a magnetic material, producing a pinned (fixed) magnetic moment (represented by the arrow 120) pinned in a direction aligned with the easy axis of the pinned layer 114. As will be appreciated, the easy axis of a magnetic layer defines the energetically favourable direction of the spontaneous magnetization in the ferromagnetic material forming the layer. This axis may be determined by various factors, including the magnetocrystalline anisotropy and the shape anisotropy of the material forming the layer. In a pinned layer, there is only one preferred direction. In comparison, the magnetic moment in a soft or free ferromagnetic material has two opposite preferred directions along the easy axis, and can be switched between them under a high enough magnetic field. Magnetic moment 120 of pinned layer 114 may be pinned in any suitable manner, as can be understood by persons skilled in the art. For example, magnetic moment 120 may be pinned by coupling pinned layer 114 with an anti-ferromagnetic layer, such as an anti-ferromagnetic layer in or adjacent to pinned layer 114. Magnetic moment 120 may also be pinned by using a hard magnetic material to form pinned layer 114. Suitable hard magnetic material may be selected from Co, Ni, Fe, Tb, Dy, combination or alloys thereof, and the like.

As depicted, the easy axis of pinned layer 114 is aligned substantially parallel to the direction of the switching magnetic field induced when current flows in both word 102A and bit line 104A. In the depicted embodiment, the easy axis of pinned layer 114 is at equal (e.g. 45°) angles to word line 102A and bit line 104A.

Magnetic moment 120 is considered “pinned” when it aligns in a preferred direction but is substantially prevented from rotation in the presence of an applied magnetic switching field induced by the electrical currents flowing through each of write lines 102A and 104A.

In one embodiment, pinned layer 114 may be a ferromagnetic layer made of a material selected from Ni, Fe, Co, a combinations or alloy thereof, or the like. A suitable alloy may be permalloy (NiFe) or CoFe, or the like.

In a different embodiment, pinned layer 114 may include a tri-layer structure known as a synthetic anti-ferromagnetic (SAF) layer, or a different multi-layer structure, as will be further described below.

As can be understood, a SAF structure can be balanced or unbalanced. In a balanced SAF, the net magnetic moment of the SAF structure is zero, or substantially zero, in the absence of an applied magnetic field so the SAF structure does not generate any significant static field in neighboring regions. In an un-balanced SAF, its net magnetic moment is substantially greater than zero, so that it will generate a significant stray static field in a neighboring region. When pinned layer 114 includes multiple sub-layers, it may be balanced or unbalanced, as will discussed below. For the purpose of illustration only, pinned layer 114 is assumed to be balanced, unless otherwise expressly specified.

Tunneling layer 118 may be formed of an insulating material, such as a dielectric material. In the depicted embodiment, tunneling layer 118 is formed atop pinned layer 114. Suitable insulating materials may be selected from AlO, Al₂O₃, TaO, MgO, a combinations thereof, and the like.

Both pinned layer 114 and tunneling layer 118 may be formed in any suitable manner, using suitable conventional techniques for forming pinned and tunneling layers in MTJs.

In the depicted embodiment, free layer 116 is formed atop tunneling layer 118. Free layer 116 has a free magnetic moment 122 that is rotatable and reorientable under an applied magnetic switching field that exceeds a switching threshold. In one embodiment, free layer 116 has an easy axis that is parallel to the easy axis of pinned layer 114, which is the preferred axis of alignment for magnetic moment 122 in the absence of an applied magnetic field. Free layer 116 has a multi-layered structure, which will be illustrated below.

The three layers 114, 116 and 118 form an MTJ. Memory cell 108A may be configured and provided with a sensing structure (not shown) for measuring its electrical resistance, such as by electrically connecting the MTJ in series with a diode or other semiconductor device. Such structures and devices and other necessary or optional structures/devices for proper operation and function of an MTJ memory cell and an MRAM device can be readily understood and implemented by persons skilled in the art. For example, useful additional components or features present in a conventional MTJ or MRAM device may be provided in memory cells 108 and device 100, in addition to the features and components described below. As such additional features and components are not the focus of the present invention, they are omitted in the drawings for clarity. Some examples of such features and structures are disclosed in U.S. Pat. Nos. 5,640,343 to Gallagher et al. (hereafter “Gallagher”), 6,531,723 to Engel et al. (herein after “Engel I”), 6,545,906 to Savtchenko et al. (herein after “Savtchenko”), 6,633,498 to Engel et al. (hereinafter “Engel II”), 6,956,763 to Akerman et al., (hereinafter “Akerman”), 6,967,366 to Janesky et al. (hereinafter “Janesky”), 6,992,910 to Ju et al. (hereinafter “Ju”), and 7,164,698 to Jeong et al. (hereinafter “Jeong”), the contents of each one of which are incorporated herein by reference.

The operation of the MTJ in memory cell 108A is similar to a typical conventional MTJ, with some differences which are described herein. Similar to operating a conventional MTJ, to set memory cell 108A in a particular memory state, electrical current pulses are simultaneously applied to each of word line 102A and bit line 104A, to generate or induce the proper switching magnetic field for setting magnetic moment 122 in a desired direction. As noted, each magnetic cell 108 may be programmed by applying a magnetic field parallel to the easy axis A. Assuming currents 110 and 112 flow in the directions shown in FIG. 2, each current 110 or 112 generates a respective magnetic field 124 or 126 in free layer 116, as shown in FIG. 4. Fields 124 and 126 may have matching (e.g. substantially equal) strengths so that the net magnet field 128 is parallel to the preferred axis of alignment (line A). The direction of switching field 128 is dependent on the current directions, and can be either parallel or anti-parallel to the initial direction of free magnetic moment 122, along axis A, depending on the desired memory state to be written. In FIG. 4, field 128 is parallel to magnetic moment 122. Currents 110 and 112 should also be sufficiently high so that field 128 exceeds the switching field threshold. Switching field 128 may be removed by stopping current flowing in write lines 102A/104A. After switching field 128 is removed, magnetic moment 122 may remain re-oriented in the direction that is either parallel or anti-parallel to the direction of applied switching field 128, depending on the particular construction of free layer 116, the reasons of which will become clear below.

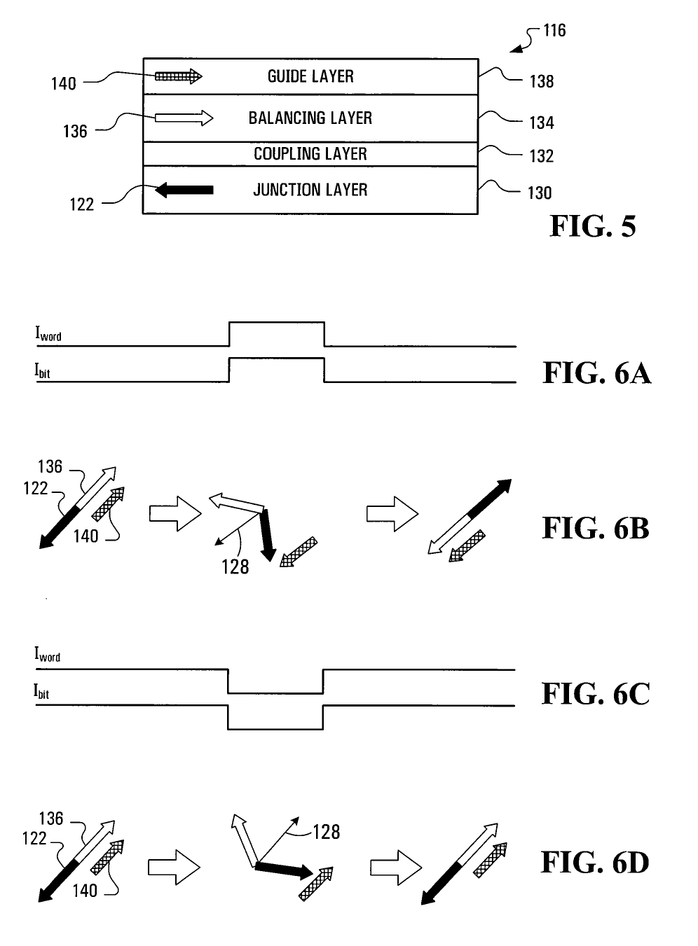

A particular structure of free layer 116 is shown in more detail in FIG. 5, which is exemplary of an embodiment of the present invention.

Free layer 116 includes a ferromagnetic junction layer 130 having a free magnetic moment 122, an anti-ferromagnetic coupling layer 132, and a ferromagnetic balancing layer 134 whose magnetic moment 136 is also free to rotate under the applied switching field 128 (see FIG. 4) and is anti-ferromagnetically coupled to magnetic moment 122 for balancing junction layer 130. Junction layer 130 is adjacent to tunneling layer 118 and forms part of the MTJ junction, and thus the direction of its magnetic moment 122 affects the electrical resistance through the MTJ junction. Layers 130 and 134 are anti-ferromagnetically coupled through coupling layer 132. Thus, magnetic moments 122 and 136 are anti-parallel in the absence of the applied switching field and are aligned with the easy axes of layers 130 and 134, which are both parallel to the easy axis of pinned layer 114. The mentioned easy axes are all parallel to line A shown in FIGS. 1 and 4, which will be referred to as the preferred axis of alignment herein.

As can be appreciated, layers 130, 132, and 134 form a tri-layer SAF structure, which is similar to some SAFs used in free layers of some conventional magnetoresistive memory cells, including those disclosed in the aforementioned references. For the purpose of illustration, it is assumed below that the SAF structure formed by layers 130, 132, 134 is balanced, that is, magnetic moments 122 and 136 have the same or substantially the same magnitude, and their net magnetic moment in the absence of an external field is zero or near zero. However, the SAF structure may be slightly unbalanced in different embodiments. As can be appreciated, the magnitude of the total magnetic moment of a ferromagnetic layer is dependent on a number of factors which can be adjusted to adjust the resulting magnetic moment. For example, one or more of the component materials, the thickness and the size of the layer may be adjusted. Each of ferromagnetic layers 130 and 134 may be formed of a suitable ferromagnetic material. A suitable material may be selected from Co, Ni, Fe, any combinations or alloys thereof, and the like. Coupling layer 132 may be formed from a material selected from Cu, Ru, Au, Ta, a combination thereof, and the like. An anti-ferromagnetic coupling material may also include at least one of the elements Ru, Os, Ti, Cr, Rh, Pt, Cu, Pd, Ta, Au, and a combination thereof. An anti-ferromagnetic layer may also include a material selected from IrMn, NiMn, PtMn, FeMn, or the like.

In one embodiment, each of layers 130 and 134 may be made of a CoFe alloy and coupling layer 132 may be made of Ru.

In addition to the SAF structure, however, free layer 116 also includes a further magnetic layer 138 that acts as a guide layer (hereinafter guide layer 138), which has a magnetic moment 140 that is weakly coupled to balancing magnetic moment 136, and is not, or more weakly, coupled to free magnetic moment 122. The coupling between magnetic moments 136 and 140 can be either anti-ferromagnetic or ferromagnetic. For example, an additional anti-ferromagnetic coupling layer may be provided between layers 134 and 138 to provide the anti-ferromagnetic coupling. For ease of description and simplicity, it is assumed below that they are ferromagnetically coupled, and they will align in the same direction in the absence of an applied switching field. Persons skilled in the art can readily modify the embodiments described herein for anti-ferromagnetic coupling, after reviewing this disclosure.

The magnitude of coupling field from guide layer 138 should be in a suitable range, such that it is strong enough to generate a coupling field to balancing layer 134 but is sufficiently weak so that, in the absence of an applied field, magnetic moment 136 will stay substantially aligned with its easy axis, or line A shown in FIG. 4. Guide magnetic moment 140 is also free to rotate under an applied magnetic field or an external field including the field generated by magnetic moment 136. The easy axis of guide layer 138 may be parallel to the easy axis of balancing layer 134. Thus, in the absence of an applied field, balancing magnetic moment 140 will align in parallel with balancing magnetic moment 136.

Guide layer 138 as depicted is a single magnetic layer, which may be formed of a ferromagnetic material selected from Co, Ni, Fe, their alloys, or the like. In different embodiments guide layer 138 may also include multiple sub-layers. In a different embodiment, it may include two stacked layers, one formed of CoFe and another formed of NiFe. In another embodiment, guide layer 138 may be an un-balanced tri- or multi-layer SAF, which may be useful for reducing static field to balanced layers 134 and 130. For the purpose of illustration, only the single layer embodiment is further described below. In one embodiment, guide layer 138 may have a low coercivity, such as less than 100 Oe, and an effective thickness less than 5 nm.

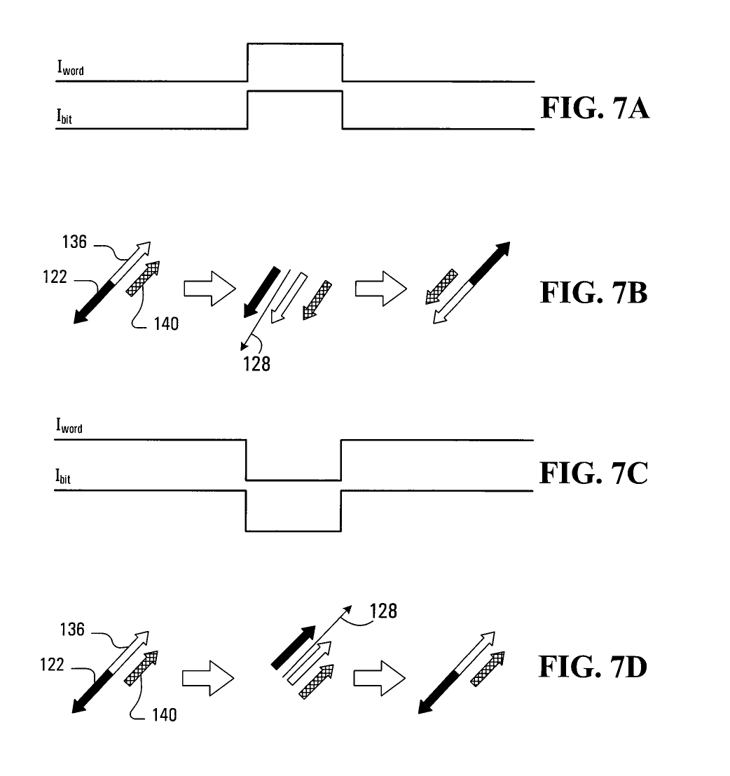

In operation, free magnetic moment 122 can be re-oriented as illustrated in FIGS. 6A, 6B, 6C, 6D, 7A, 7B, 7C and 7D. For the purpose of illustration and easy understanding, it is assumed that magnetic moments 122, 136 and 140 are initially aligned in the directions as shown on the left hand side in FIGS. 6B, 6D, 7B, and 7D. It will become clear below that, the writing result is independent of the initial directions of these magnetic moments, but only dependent on the directions of electrical currents 110 and 112.

In a normal writing mode, a pulse of current 110 and a pulse of current 112 are applied respectively and simultaneously to word line 102A and bit line 104A, as shown in FIGS. 6A and 6C respectively, to generate applied magnetic switching field 128 in free layer 116, which is aligned with the preferred axis of alignment axis A, in the respective direction as shown in either FIG. 6B or 6D. As can be appreciated, by applying current creating signals in a selected direction, applied field 128 may be applied in a selected direction to write a selected memory state. It is assumed below that memory cell 108A is in a “0” state when pinned magnetic moment 120 and free magnetic moment 122 are in the same direction, and memory cell 108A is in a “1” state when pinned magnetic moment 120 and free magnetic moment 122 are in the opposite direction. In the cases shown in FIGS. 6A to 6D, it is assumed that field 128 is not saturated. That is, it is not strong enough to completely overcome the coupling between magnetic moments 122 and 136. Field 128 is, however, strong enough to align guiding magnetic moment 140 in the direction of field 128.

In the case of FIGS. 6A and 6B, it is assumed that memory cell 108A initially stores a “1” and field 128 is applied to write a “0” to memory cell 108A. As depicted in FIG. 6B, field 128 is applied in the same direction as the initial direction of free magnetic moment 122. In the presence of field 128, the coupled magnetic moments 122 and 136 rotate away from their initial directions, as shown in the middle portion of FIG. 6B. Magnetic moments 122 and 136 in the new directions are no longer anti-parallel and produce a non-zero net magnetic moment that is aligned in the direction of the field direction. The new angle between magnetic moments 122 and 126, and the magnitude of their net magnetic moment depends on the strength of field 128. The larger the strength of field 128, the smaller the angle and the larger the net magnetic moment. On removal of field 128, magnetic moments 122 and 136 will again become aligned with the preferred alignment axis A, and become anti-parallel. If guiding magnetic moment 140 were not present, magnetic moments 122 and 136, assuming they are balanced, would have had equal or near equal chances of returning to their initial directions or reversing their directions. However, in the presence of guiding magnetic moment 140, balancing magnetic moment 136 will align in the direction of guide magnetic moment 140, i.e. the direction of the earlier applied field 128. This is because the guiding magnetic moment is now aligned in the field direction (regardless of its initial direction) and because the coupling between magnetic moments 136 and 140 is stronger than the coupling, if any, between magnetic moments 122 and 140. Consequently, magnetic moment 122 is aligned opposite of the direction of applied field 128, as shown on the right hand side in FIG. 6B. In the case shown in FIG. 6B, magnetic moment 122 flips its direction due to the application of field 128, and the memory state of memory cell 108A is switched.

In the case of FIGS. 6C and 6D, it is assumed that memory cell 108A still initially stores “1” but field 128 is applied to write “1” to memory cell 108A. As depicted in FIG. 6D, field 128 is applied in the direction opposite to the initial direction of free magnetic moment 122. As can be seen, the responses of magnetic moments 122, 136, and 140 to the application and removal of field 128 and the switching results are similar to those of FIG. 6B. The final direction of magnetic moment 122 is always opposite of the direction of applied field 128, regardless of the initial direction of magnetic moment 122 and the strength of applied field 128. As a result, the memory state of memory cell 108A remains the same (“1”) after removal of the applied field in FIG. 6D.

The same write results are obtained when field 128 is saturated as illustrated in FIGS. 7A to 7D. It is assumed that the saturated field 128 resulted from the applied signals shown in FIGS. 7A and 7C is strong enough to cover come the coupling between magnetic moments 122 and 136 and align all three magnetic moments 122, 136 and 140 in the same direction as that of field 128, as illustrated in FIG. 7B or 7D. In these cases, after field 128 is removed, the anti-ferromagnetic coupling between magnetic moments 122 and 136 will cause one of them to flip to the opposite direction. Without an external biasing field, each of them would have had an equal chance to flip. However, due to the presence of guiding magnetic moment 140 and the biasing field it exerts in balancing layer 134, magnetic moment 136 will remain in place and magnetic moment 122 will flip to the direction that is opposite of that of field 128, as shown at the right hand side of FIG. 7B or 7C.

As can be seen, the final directions of magnetic moments 122, 136, and 140 after the application and removal of field 128 in FIG. 7B or 7D are the same as those shown in FIG. 6B or 6D, respectively. Therefore, the switching result does not change when field 128 is saturated, i.e. the final direction of magnetic moment 122 is always opposite of the direction of applied field 128, regardless of the initial direction of magnetic moment 122 and the strength of applied field 128.

It can now be understood that the initial direction of magnetic moment 140 does not affect the resulting state of memory cell 108A, as it will always be aligned with the direction of switching field 128, and “guide” balancing magnetic moment 136 to align in the same direction after field removal.

In contrast, if guide layer 138 were absent in free layer 116, magnetic moments 122 and 136 would have had equal or similar chances of aligning in the direction of field 128 after its removal, and consequently, the writing result would be unpredictable and the rate of write error would be high.

Indeed, in conventional MTJ and MRAM devices, direct write mode is not available when the free layer is balanced or nearly balanced, because the rate of failed write would be high. In the case where the free layer is unbalanced, the switching field must be limited to below a saturation threshold. Otherwise, the rate of write error may also be high. The write result would need to be verified and re-write is required when a first attempt fails.

In the present embodiment, each write operation described above will set memory cell 108A in a state that is dependent on the directions of electrical currents 110 and 112, but independent of the initial state of the cell. As each write operation positively set the state of memory cell 108A regardless of its initial state, it is not necessary to pre-read memory cell 108A before each write operation.

Further, data retention is also good in memory cells 108A, as random fields resulted from thermal fluctuation, or fields generated in half-selected cells are unlikely to alter the state of the cell.

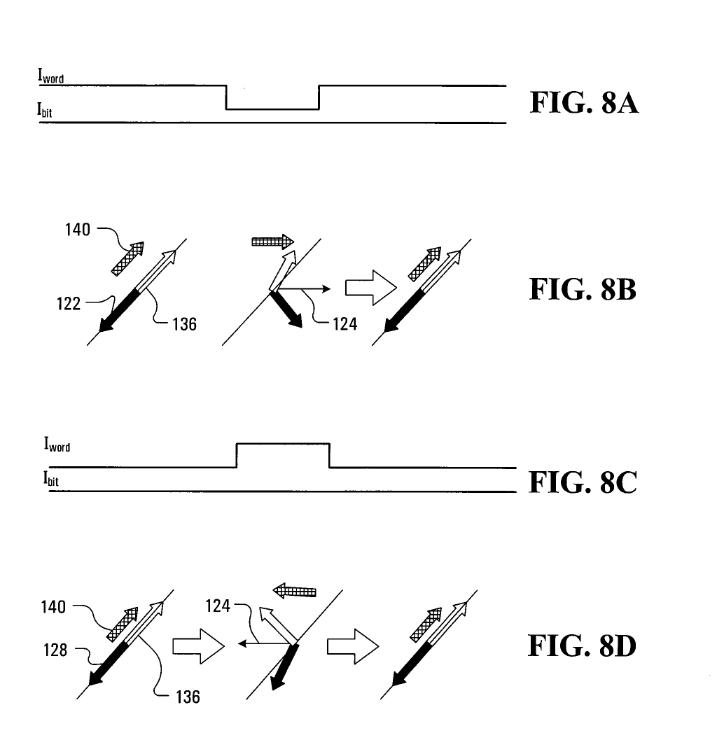

The responses of magnetic moments 122, 136 and 140 to the applied field in a half-selected cell are illustrated in FIGS. 8A, 8B, 8C and 8D.

If memory cell 108A is half-selected by passing a current pulse in word line 102A only as shown in FIG. 8A or 8C, the direction of applied magnetic field 124 in memory cell 108A and the directional changes of the magnetic moments are as shown in FIGS. 8B and 8D, respectively. As illustrated, in both cases after field 124 is removed, each of magnetic moments 122 and 136 returns to its initial direction, and the initial state of memory cell 108A is retained.

It can be appreciated that the memory state of memory cell 108A will also not change if a current pulse is induced only in bit line 104A.

Further, it can be understood now that, as long as the current pulses in word line 102A and bit line 104A overlap in time, the memory state of memory cell 108A can be switched, and it is not necessary that the front and tailing edges of the pulses be precisely timed or be in a particular sequence. Thus, the pulses do not necessarily have to have the shapes shown in FIGS. 6A and 7A, nor do they have to have the exact relative timing as shown.

As now can be appreciated, some modification may be made to memory cell 108A while still retaining the guiding effect of a guide layer. For example, in memory cell 108A pinned layer 114 may be unbalanced instead of being balanced. When pinned layer 114 is unbalanced, it may exert an additional static stray field in free layer 116. In such a case, as long as guiding magnetic moment 140 is sufficiently high so that it overcomes the effect of the static stray field generated by the unbalanced pinned layer, balancing magnetic moment 136 will still be “guided” by guide magnetic moment 140 to follow the direction of applied field 128.

It is not necessary to guide balancing magnetic moment 136. Instead, a guide magnetic moment may be more strongly coupled to free magnetic moment 122 than to balancing magnetic moment 136. In this case, free magnetic moment 122, instead of balancing magnetic moment 136, will be guided to align with the field direction when the switching field is removed. Thus, predictable write results can still be obtained.

The guiding coupling between a guide layer and a guided layer may also be effected if the two layers are anti-ferromagnetically coupled, instead of ferromagnetically coupled, as can be understood by persons skilled in the art.

Further, additional layers may be added to memory cell 108A as illustrated below.

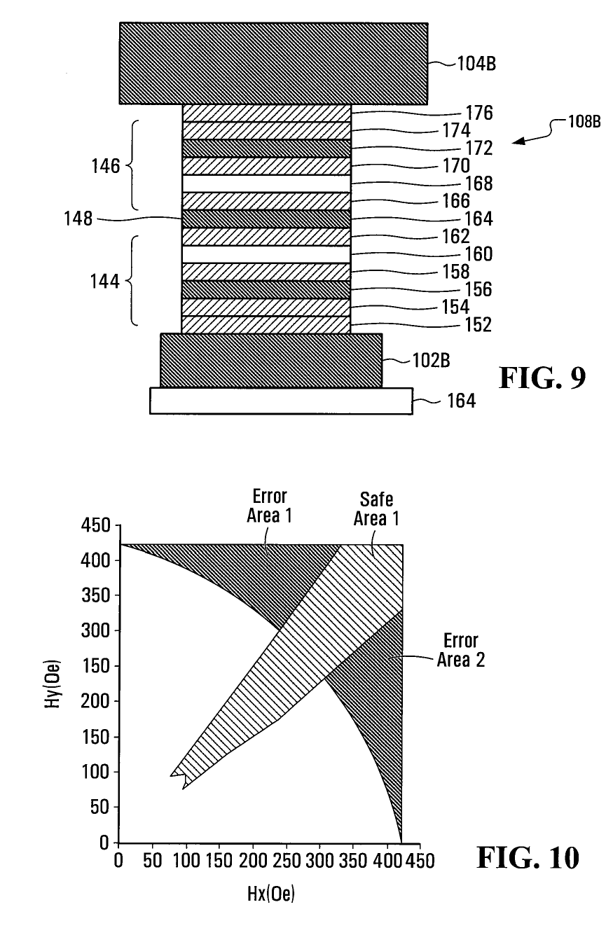

FIG. 9 illustrates a variant of memory cell 108A, cell 108B, exemplary of an embodiment of the present invention, which may be used to replace cell 108A. Like cell 108A, cell 108B includes a pinned portion 144, a free portion 146, and a tunnel layer 148 sandwiched therebetween. As cell 108A, cell 108B is sandwiched between a word line 102B and a bit line 104B.

Pinned portion 144 may include a SAF structure 150. SAF structure 150 may include a buffer layer 152, a seed layer 154, an anti-ferromagnetic (AFM) layer 156, a first ferromagnetic layer 158, a spacer layer 160, and a second ferromagnetic layer 162. Buffer layer 152 may be used to promote the adhesion or bonding between the cell layers and write line 102B (or a substrate that supports the cell layers). Seed layer 154 may be used to facilitate the formation of a preferred crystal structure in AFM layer 156. Layers 158 and 162 are anti-ferromagnetically coupled to each other through layer 160. The magnetic moments of layers 158 and 162 are pinned by AFM layer 156.

Buffer layer 152 may be formed of Ta, Ti or the like. Seed layer 154 may be formed of Ni, Fe, Co, a combination or alloy thereof, or the like. Anti-ferromagnetic layer 156 may be formed of IrMn, NiMn, PtMn, FeMn, any combination thereof, or the like. Ferromagnetic layers 158 and 162 may be formed of Ni, Fe, Co, a combination or alloy thereof, or the like. Spacer layer 160 may be formed of Ru, Cu, Ta, a combination thereof, or the like.

In this embodiment, the magnetic moments of ferromagnetic layers 158 and 162 may be anti-parallel. For example, spacer layer 160 may anti-ferromagnetically couple layers 158 and 162. One of layers 158 and 162 may be pinned by an adjacent anti-ferromagnetic layer such as layer 156.

Pinned portion 144 and word line 102B may be formed on a substrate 164, such as SiO₂. In a different embodiment, a pinned portion may be formed directly on a substrate which is then placed between the write lines. In another embodiment, word line 102B may also serve as a substrate. The electrical sensing structure for measuring the resistance of the MTJ may also be partially integrated within the substrate, write line 102B or 104B, or pinned portion 144.

In a particular embodiment, pinned portion 144 may be formed on a substrate and have a multi-layered structure including layers of, in the order given, substrate, a buffer layer formed of Ta, a seed layer formed of NiFeCr, an anti-ferromagnetic layer formed of IrMn, a ferromagnetic layer formed of CoFe, a spacer layer formed of Ru, and a ferromagnetic layer formed of CoFe.

Pinned portion 144 may also have a pinned SAF multi-layer that includes more than two ferromagnetic layers, which are anti-ferromagnetically coupled. In a different embodiment, pinned portion 114 may have a multi-layer structure that includes more than two ferromagnetic sub-layers (not shown).

In pinned portion 144, the magnetic moment of the ferromagnetic sub-layer (layer 162 as depicted) that is closest to the tunnel layer 148 may correspond to pinned magnetic moment 120. This sub-layer (e.g. layer 162) may be pinned directly or through coupling with another layer, such as layer 158. A pair of adjacent ferromagnetic sub-layers in pinned portion 144 may be anti-ferromagnetically coupled, such as by sandwiching an anti-ferromagnetic sub-layer therebetween.

Some suitable embodiments of pinned layer 114 or pinned portion 144 are known and have been described, for example, in some of the aforementioned references.

The free portion 146 may include a ferromagnetic free layer 166, a coupling layer 168, a ferromagnetic balancing layer 170, a spacer layer 172, a guide layer 174, and a capping layer 176.

Layers 166, 168, 170 and 174 may be formed similarly as layers 130, 132, 134, and 138, respectively. As can be understood, layers 166, 168, and 170 form a SAF structure.

Spacer layer 172 sandwiched between the SAF structure and guide layer 174 weakly couples layer 170 and guide layer 174. Spacer layer 172 may be formed of Cu, Ru, Au, Ta, or the like, and can be either anti-ferromagnetic or ferromagnetic.

Capping layer 176 may be formed of Cu, Ru, Au, Ta, or the like.

In a different embodiment, a free portion may include multiple tri-layer SAF structures.

To form a ferromagnetic free layer in a memory cell 108, the properties of the ferromagnetic free layer may be chosen with regard to desired writing (switching) field and stability of the memory cell against other factors such as field excursions and desired value of magnetoresistance. For example, permalloy (NiFe) responds to smaller switching fields but provide lower magnetoresistance, and therefore lower output signal. CoFe alloys require higher switching fields but have higher magnetoresistance and greater stability against field excursions. CoFe layers also have greater magnetostriction which may be utilized to set the uniaxial anisotropy, but may also lead to non-uniform properties in the patterned arrays. Improved corrosion resistance can be obtained by adding Cr to the Co or CoFe. In some embodiments, a suitable free layer may include a thin CoFe layer in contact with an Al₂O₃ tunnel layer, for large magnetoresistance, and a thicker layer of low magnetostriction magnetic material, such as NiFe, which forms the bulk of the free layer.

The properties of the pinned layer may be chosen with regard to desired stability against field excursions and desired value of magnetoresistance.

Anti-ferromagnetic layers may also be formed of a NiMn layer.

The benefits of a guide layer in memory cell 108A or 108B, and free layer 116 or free portion 146 that has such a guide layer can be further appreciated from FIG. 10, which shows a simulated phase diagram for cell 108B. The x and y axes indicate the strengths of applied field in x and y directions. The safe (error-free) and error areas in the phase diagram are as indicated. As can be seen, for a selected cell, the safe writing field range can extend far beyond 450 oersteds (Oe). For a half-selected cell, write error only become significant when the applied field is more than 300 Oe.

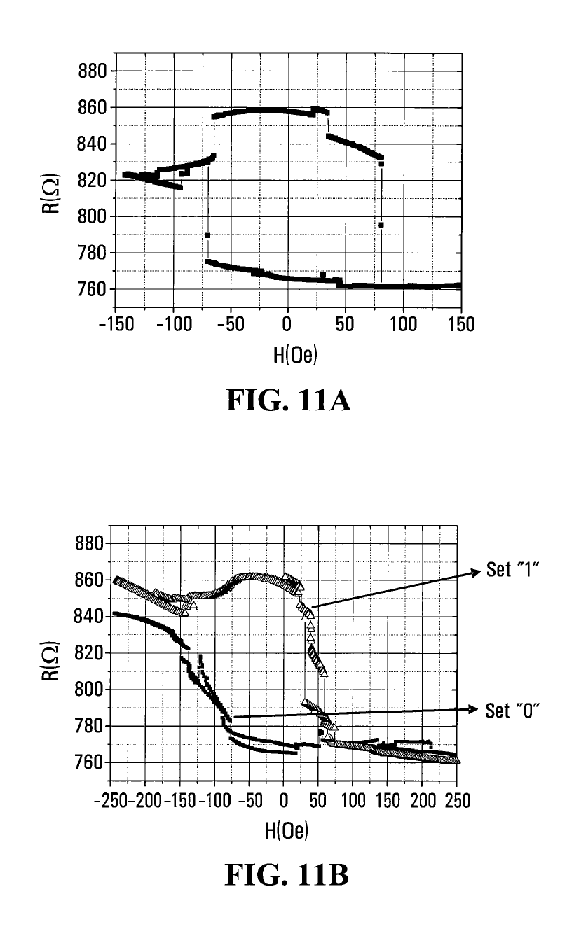

FIGS. 11A and 11B show experimental results of measured resistance as functions of applied fields in sample memory cells having structures similar to that depicted in FIG. 9, when the cell was selected (FIG. 11A) or half-selected (FIG. 11B) respectively. The x-axis indicates the applied magnetic switching field in the cell. The positive values represent a field direction for writing “1”. As illustrated in FIGS. 11A and 11B, a selected cell was switched and a half-selected cell could not be switched. The y-axes indicate the measured cell resistance.

In the tested sample cells, the cell size was 1 um by 0.6 um. The cell was formed in a multi-layer film, which include the following layers, in the order given: substrate, Ta (5), Cu (50), Ta (10), CoFe (2.5), Ru (0.8), CoFe (2), Cu (2.2), NiFe (2), CoFe (1), Ru(2.0), NiFe (2), CoFe (1), AlOx (1.1), CoFe (1.5), Ru (0.8), CoFe (6), Ru (0.8), CoFe (5), IrMn (8), and Ta (10). The number in parentheses following the material of each layer indicates the thickness of the respective layer in nanometers.

As can be seen from FIG. 11A, in a selected cell, where the total field is in the easy axis direction (see FIG. 6), the state of the cell was switched when the net applied field was larger than 57 Oe, as indicated by the steps shown around +57 and −57 Oe. The switching field threshold was thus about 57 Oe.

FIG. 11B shows the resistance change in a half selected cell, where the applied field direction was at about 45 degrees relative to the easy axis direction, by applying a current signal to only one write line (see FIG. 8A or 8C). As can be seen, the cell was not switched after applying a field of up to 250 Oe, when the cell was initially in either the “0” or “1” state. In comparison, when currents are applied to both write lines, a field of only 57 Oe could switch the cell successfully (see FIG. 11A). This test result indicates that the tested memory cell was directly writable and reliable, and could avoid errors due to half-selection.

As now can be appreciated, some additional variations or modifications to the above described embodiments are possible. For example, word lines 102 and bit lines 104 may swap locations, relative to memory cells 108. Word lines, or bit lines, may be connected to the diodes for measuring the resistance of the cells. The resistance of each memory cell 108 may be measured in any suitable manner, as can be understood by those skilled in the art.

To increase signal strength, one memory cell 108 may include more than one MTJs, and one MTJ may include more than one free layers or more than one pinned layers to provide a stronger free or pinned magnetic moment. Multiple free layers or MTJs may be vertically stacked to limit lateral size of the cell.

While in free layer 116 shown in FIG. 5 balancing magnetic moment 136 of balancing layer 134 is guided by a guiding magnetic moment 140, in a different embodiment, the magnetic moment (122) of the junction layer (130) may be guided by a suitable guiding magnetic moment and the balancing layer (134) that is anti-ferromagnetically coupled to the junction layer (130) may be free to rotate. The response of the magnetic moment of such a junction layer can have similar responses to an applied magnetic field, except that the magnetic moment is now aligned in the same direction as the field direction, as can be understood by persons skilled in the art. Thus, similar benefits and advantages may be obtained, as in free layer 116 shown in FIG. 5. In such a case, the guiding layer may be located closer to the junction layer than to the balancing layer.

It should also be understood that a write line, such as word line 102A may be adapted for use as a read line for reading cell 108A.

For clarity, it is also noted that a ferromagnetic material as referred to herein includes a ferrimagnetic material.

Embodiments of the present invention can have many desirable characteristics, such as high cell density, high write/read speed, non-volatility, low production cost, and long lifetime.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A magnetoresistive memory cell, comprising:
a magnetic tunnel junction (MTJ) comprising
a magnetic layer having a pinned magnetic moment,
a tunneling layer adjacent said magnetic layer, and
a free layer adjacent said tunneling layer, comprising
a first ferromagnetic layer having a first free magnetic moment, and
a second ferromagnetic layer having a second free-magnetic moment anti-ferromagnetically coupled to said first free magnetic moment, said first and second magnetic moments aligning with a preferred axis of alignment in the absence of an applied magnetic field,
said MTJ having an electrical resistance dependent on the direction of one of said first and second free magnetic moments; and
a guide layer formed of a ferromagnetic material providing a guiding magnetic moment, said guide layer configured and positioned so that said guiding magnetic moment is more strongly magnetically coupled to said second free magnetic moment than to said first free magnetic moment, and is aligned with said axis in the absence of said applied magnetic field.

2. The magnetoresistive memory cell of claim 1, wherein said first ferromagnetic layer is adjacent to said tunneling layer.

3. The magnetoresistive memory cell of claim 1, wherein said guiding magnetic moment is ferromagnetically coupled to said second free magnetic moment.

4. The magnetoresistive memory cell of claim 1, wherein said guiding magnetic moment is anti-ferromagnetically coupled to said second free magnetic moment.

5. The magnetoresistive memory cell of claim 1, comprising an anti-ferromagnetic coupling layer sandwiched between said first and second ferromagnetic layers, providing anti-ferromagnetic coupling between said first and second free magnetic moments.

6. The magnetoresistive memory cell of claim 1, comprising a spacer layer sandwiched between said second ferromagnetic layer and said guide layer.

7. The magnetoresistive memory cell of claim 1, wherein said guide layer has a coercivity of less than 100 Oe.

8. The magnetoresistive memory cell of claim 1, wherein said guide layer has a thickness of less than 5 nm.

9. The magnetoresistive memory cell of claim 1, wherein said first and second free magnetic moments are balanced.

10. The magnetoresistive memory cell of claim 1, wherein said pinned layer comprises a ferromagnetic layer.

11. The magnetoresistive memory cell of claim 1, wherein said pinned layer comprises a synthetic anti-ferromagnetic (SAF) structure, said SAF structure comprising a third ferromagnetic layer and a fourth ferromagnetic layer anti-ferromagnetically coupled to said third ferromagnetic layer, said third ferromagnetic layer having a third magnetic moment and said fourth ferromagnetic layer having a fourth magnetic moment, at least one of said third and fourth magnetic moments is pinned in a direction parallel to said axis.

12. The magnetoresistive memory cell of claim 11, wherein said third and fourth magnetic moments are balanced.

13. The magnetoresistive memory cell of claim 11, wherein said pinned layer comprises an anti-ferromagnetic coupling layer sandwiched between said third and fourth ferromagnetic layers, for anti-ferromagnetically coupling said third and fourth magnetic moments.

14. The magnetoresistive memory cell of claim 11, wherein said pinned layer comprises an anti-ferromagnetic layer adjacent said third ferromagnetic layer, for pinning said third magnetic moment.

15. A memory device comprising the magnetoresistive memory cell of claim 1.

16. The memory device of claim 15, comprising electrically conductive write lines for inducing said switching field in said magnetoresistive memory cell.

17. The memory device of claim 16, wherein said write lines comprising a word line and a bit line, said word and bit lines overlapping at an intersection, said magnetoresistive memory cell being located between said word and bit lines at said intersection.

18. The memory device of claim 17, wherein said word and bit lines are perpendicular to each other.

19. The memory device of claim 18, wherein said preferred axis of alignment is at 45 degrees relative to each one of said word and bit lines.

20. A memory device comprising a plurality of memory cells each according to the magnetoresistive memory cell of claim 1.

21. The memory device of claim 20, comprising a plurality of first electrical conductive lines, and a plurality of second electrical conductive lines, said first lines overlapping said second lines at a plurality of intersections, each one of said memory cells located at an intersection between the first and second lines that overlap at said intersection.

22. The memory device of claim 20, wherein said first lines are perpendicular to said second lines.

23. The memory device of claim 22, wherein the preferred axis of alignment in each one of said memory cells is at 45 degrees relative to each one of the first and second lines that overlap at the intersection of said cell.

24. A method of aligning a magnetic moment in a free layer of a magnetic tunnel junction (MTJ), said MTJ having an electrical resistance dependent on the direction of said magnetic moment, said free layer comprising a first layer providing said magnetic moment and a second layer providing another magnetic moment anti-ferromagnetically coupled therewith, said first and second layers having an easy axis, said method comprising:
coupling a guiding magnetic moment more strongly with a first one of said magnetic moments than with a second one of said magnetic moments, said guiding magnetic moment rotatable by a magnetic field;
applying a magnetic field in a direction aligned with said axis to rotate at least one of said magnetic moments, and to align said guide magnetic moment in said direction;
removing said magnetic field, to allow re-alignment of said magnetic moments with said axis, wherein said first magnetic moment is aligned in said direction due to said coupling with said guide magnetic moment.

25. The method of claim 24, wherein said electrical resistance is dependent on the direction of said second magnetic moment.

26. The method of claim 24, wherein said guide magnetic moment is ferromagnetically coupled to said first magnetic moment.

27. The method of claim 24, wherein said guide magnetic moment is anti-ferromagnetically coupled to said first magnetic moment.
